(19) United States
(12) Patent Application Publication
(10) Pub. No.: US 2015/0068967 A1
(43) Pub. Date: Mar. 12, 2015

(54) HIGH ADSORPTION CHAMBERED FILTER

(71) Applicant: General Electric Company, Schenectady, NY (US)

(72) Inventors: Richard T. Nock, Olmstead Falls, OH (US); Cameron J. Fordyce, Bay Village, OH (US); Timothy Scott Shaffer, La Grange, GA (US)

(73) Assignee: General Electric Company, Schenectady, NY (US)

(21) Appl. No.: 14/022,286

(22) Filed: Sep. 10, 2013

(51) Int. Cl. C02F 1/28

(52) U.S. Cl. CPC C02F 1/283
USPC 210/287

(57) ABSTRACT

A filter block for a filter is provided. The filter block uses a structure constructed from bound particles of an adsorption media that create one or more chambers for the receipt of unbound particles of the adsorption media. By using a structure formed of bound particles of the adsorption media having one or more chambers that contain unbound particles of the adsorption media, the surface area available for adsorption can be substantially increased relative to conventional configurations.

The subject matter of the present disclosure relates generally to fluid filtration and, more particularly, to a filter block constructed so as to increase the surface area available for adsorption.

### BACKGROUND OF THE INVENTION

Fluid filters are commonly constructed from a variety of filter media that may be used to provide for mechanical filtration that removes particulates over a certain size. Such filter media may include e.g., polymeric webs or fibers, woven or non-wovens, having a certain pore size that precludes the passage of particulates that are occluded from passing through the pores. One or more layers of filter media may be used.

Mechanical filtration, however, is not effective at removing certain substances such a volatile organic compounds (VOCs) or chlorine from fluids such as water. These substances can be present on a molecular size level. As such, they will pass readily through the pores or openings of a typical mechanical filter. Accordingly, some filters may include one or more substances for adsorption of contaminates from the fluid. For example, water filters may include activated carbon, which can remove components that are not captured by mechanical filtration. Substances such as VOCs are removed by adsorption onto the surface of the activated carbon. Depending upon the construction, a filter that includes activated carbon or other particles can also remove certain substances through mechanical filtration as well.

Conventional constructions typically rely upon extruded filter blocks of particles of adsorption media that are bound together to form the blocks. For example, activated carbon particles may be extruded in cylindrical shape with a low temperature polymeric binder material present to hold the particles together in the shape desired. While necessary to such construction, the binder significantly impacts the effectiveness and life of the filter block. Unfortunately, the binder will mask off or blind surface area on the particles of the adsorption media used to create the block. This surface area is needed for adsorption of contaminants such as VOCs. In general, the effectiveness of a block made from e.g., activated carbon particles is reduced proportionally as the amount of binder is increased.

Accordingly, there is a need for an adsorption based filter block for fluid filtering that is constructed with significantly less binder material. Such a filter block that can substantially improve the overall surface area of the block that is available for adsorption without substantially increasing the filter size is also needed.

### BRIEF DESCRIPTION OF THE INVENTION

The present invention provides a filter block that uses a structure constructed from bound particles of an adsorption media that create one or more chambers for the receipt of unbound particles of the adsorption media. For example, the filter block may be constructed from activated carbon and binder and have one or more chambers containing unbound activated carbon. By using a structure formed of bound particles of the adsorption media having one or more chambers that contain unbound particles of the adsorption media, the surface area available for adsorption can be substantially increased relative to conventional configurations. Additional aspects and advantages of the invention will be set forth in part in the following description, or may be apparent from the description, or may be learned through practice of the invention.

In one exemplary embodiment, the present invention provides a fluid filter that includes a filter block defining a longitudinal axis. The filter block has an external surface for the inflow of unfiltered fluid. The filter block defines at least one internal fluid passageway extending along the longitudinal axis and configured for the receipt of filtered fluid from the filter block and at least one chamber extending along the longitudinal axis and separated from the at least one internal passageway by the filter block. The filter block includes particles of an adsorption media and a binder that holds the particles together into a predetermined shape of the filter block. Unbound particles of the adsorption media are received into the at least one chamber and extend along the longitudinal axis.

In another exemplary embodiment, the present invention provides a fluid filtration device. The device includes a filter block having a body constructed from particles of an adsorption media held together by a binder. An external surface of the body provides for the ingress of fluid to be filtered. An internal fluid passageway within the body is separated from the external surface by the body. At least one chamber extends within the body and is separated from the at least one internal passageway by the filter block. Binder-free particles of the adsorption media are deposited within the at least one chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 provides a perspective view of an exemplary embodiment of a fluid filtration device.

FIG. 2 illustrates a cross-sectional view of an exemplary embodiment of a filter block received within a filter housing as may be used with the exemplary filtration device of FIG. 1.

FIG. 3 is an exploded view of an exemplary embodiment of the filter block of FIG. 2.

FIG. 4 is a close up of an open end of an exemplary filter block showing the loading of unbound activated carbon into the chambers of the filter block.

FIGS. 5, 6, 7, and 8 illustrate exemplary embodiments of filter blocks of the present invention.

FIG. 9 provides a plot of certain data as will be further described below.

The use of the same or similar reference numerals throughout the figures denotes the use of the same or similar features.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

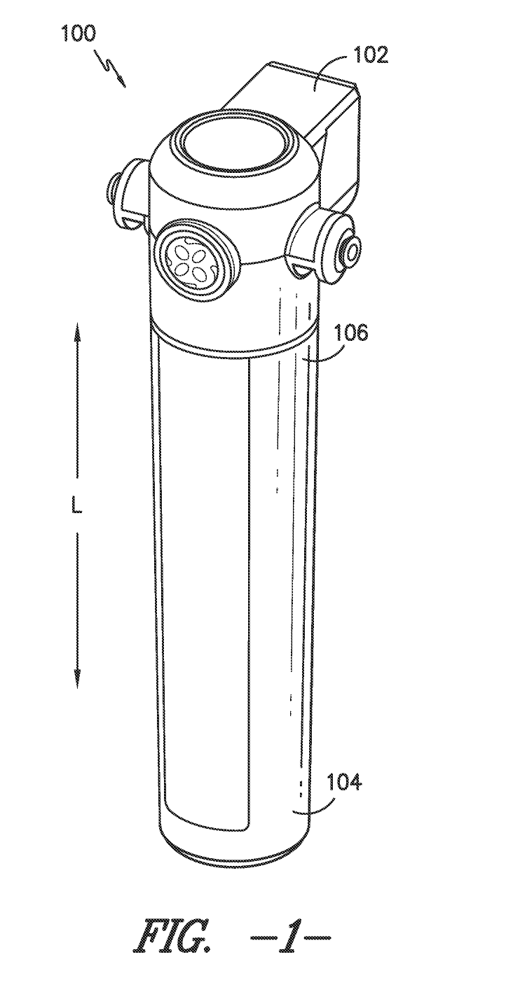

FIG. 1 provides a perspective view of an exemplary embodiment of a fluid filtration device 100 of the present invention, which may be used to filter e.g., potable water in residential or commercial applications. By way of example, fluid filtration device 100 might be installed under a kitchen sink to filter water supplied thereto or might be installed in the water supply line to an entire home. Other applications apply as well. Fluid filtration device 100 can provide for mechanical filtration of particulates from potable water. In addition, because fluid filtration device 100 uses activated carbon as will be further described, it can also remove VOCs, chlorine, and/or other substances by adsorption onto the activated carbon.

It should be understood, however, that the present invention is not limited to water filtration. Using the teachings disclosed herein, one of ordinary skill in the art will understand that the present invention may be used in other fluid filter applications including filtration of gases and/or other liquids. In addition, while activated carbon will be used herein as an example of the adsorption media that may be to used construct the filter block, other adsorption media (and combinations thereof) may be used as well for construction of the filter block. For example, activated carbon, sodium bicarbonate, titanium dioxide, ceramic materials, aluminosilicates, analcime, chabazite, clinoptilotie, heulandite, natrolite, and stilbite and others may be used separately or in combination as the adsorption media.

For the exemplary embodiment shown in FIG. 1, fluid filtration device 100 includes a filter housing 104 attached at end 106 to a filter manifold 102. A variety of different configurations of inlet and outlet connections may be provided for the connection of filter manifold 102 to a water supply. Filter manifold 102 and housing 104 may be constructed e.g., from one or more molded plastics. FIG. 1 provides an example of the appearance and configuration of filter housing 104 and filter manifold 102. Other shapes and configurations having a different appearance may be used as well.

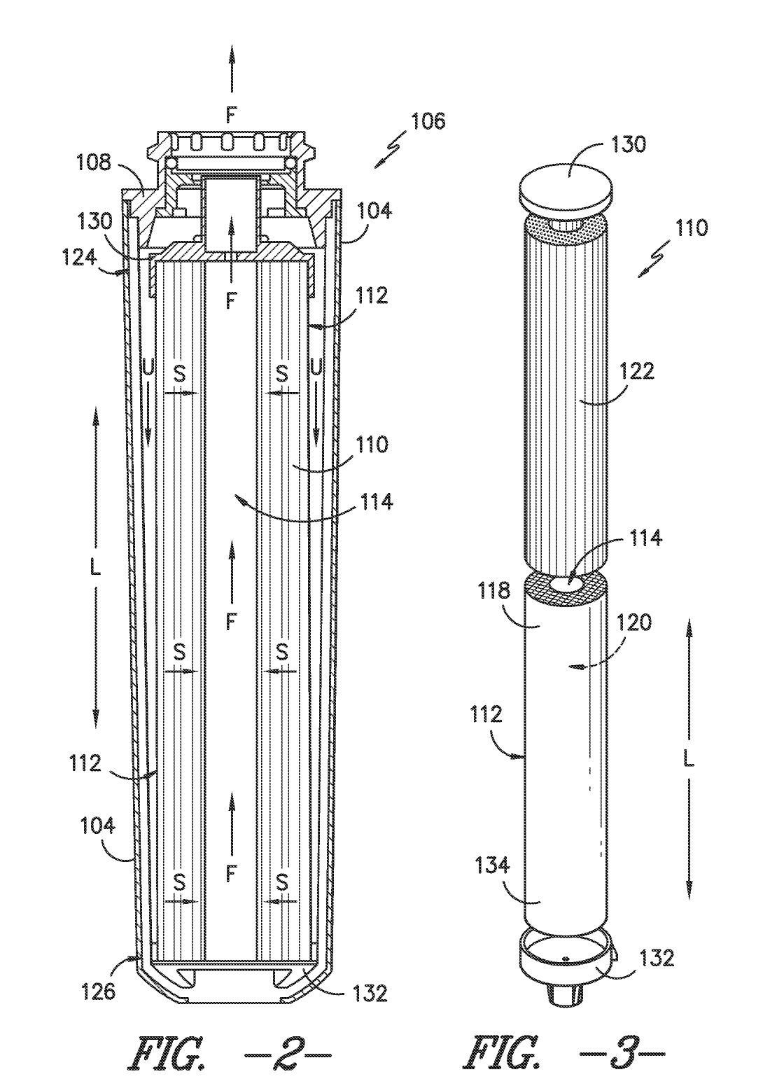

Referring now to FIG. 2, a filter block 110 is positioned within filter housing 104. As such, filter block 110 can be replaced by disconnecting filter housing 104 from filter manifold 102 and replacing with a new filter housing containing a new filter block. Other embodiments of the invention, filter block 110 may be removably received within filter housing 104 so that only block 110 need be replaced. Other constructions may be used as well. By way of example, it may be necessary to replace filter block 110 once its activated carbon is substantially loaded through adsorption of one or more substances from the water being filtered.

Filter block 110 defines a longitudinal axis L extending along its length. As shown, during operation, unfiltered water is fed to fluid filtration device 100 and generally travels along longitudinal axis L in a first direction (arrows U) in filter housing 104, inflows filter block 110 through its external surface 112, and is filtered as it passes (arrows S) through filter block 110. Having passed through filter block 110, filtered water is received into an internal fluid passageway 114 defined by filter block 110. Filtered water then generally flows in a second direction (arrows F) along the longitudinal axis L of filter block 110 and exits filter housing 104 and then filter manifold 102 for supply to e.g., a faucet, valve, or other water supply. It should be understood that the fluid flow path within filter manifold 102 and housing 104 described is provided by way of example only—others may be used as well.

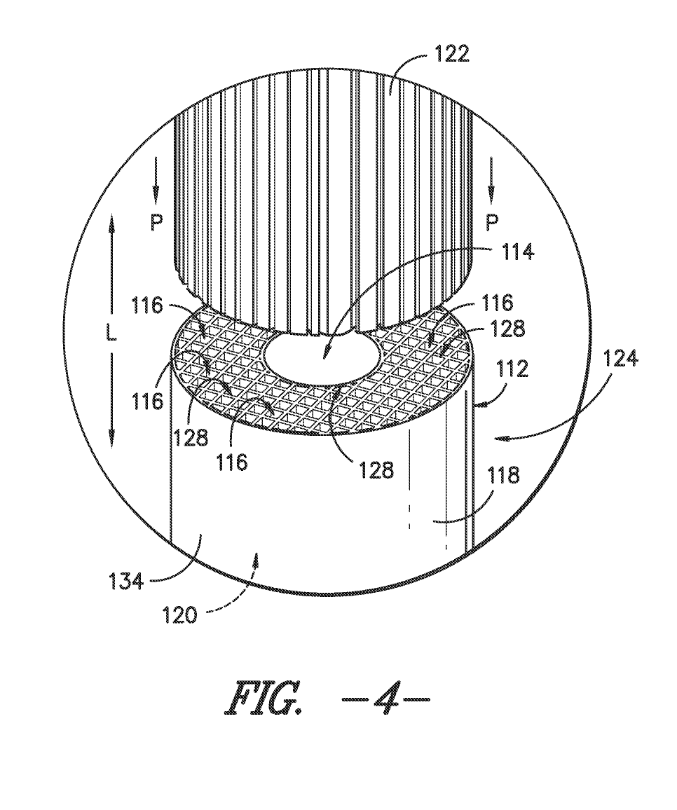

An exploded view of the exemplary filter block 110 is provided in FIG. 3. A body 134 of filter block 110 is constructed from activated carbon particles 118 that are held together in a predetermined shape (e.g., cylindrical as shown in FIG. 3) by a binder 120. By way of example, binder 120 may be polymeric, ceramic, or fibrous material that holds together the carbon particles in the predetermined shape desired for the body 134 of filter block 110. A variety of shapes may be used for filter block 110.

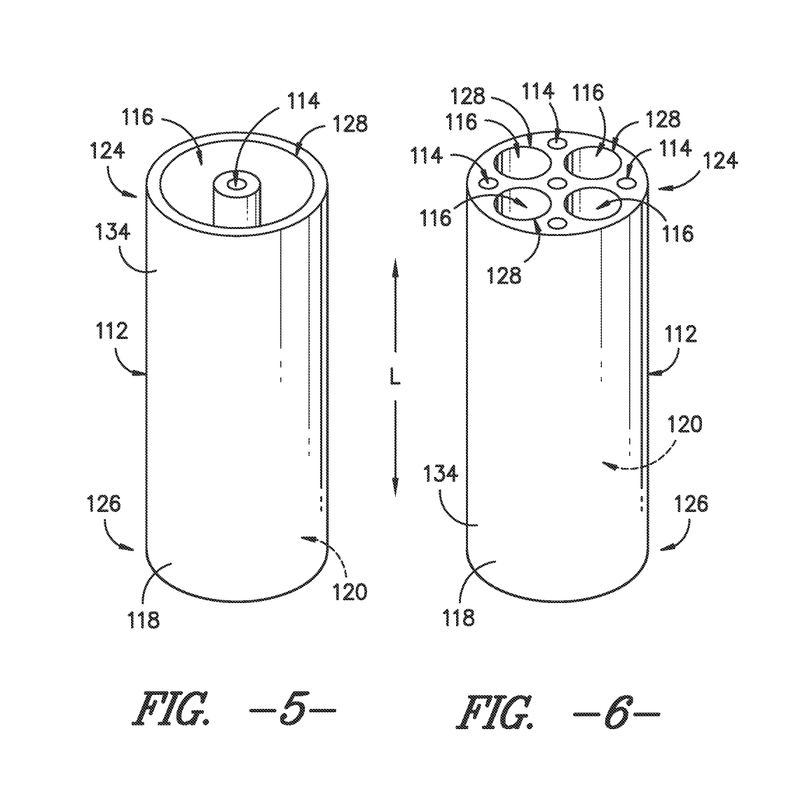

Referring now to FIGS. 3 and 4, for this exemplary embodiment, filter block 110 defines a plurality of chambers 116 that are separated from internal fluid passageway 114 by the construction of body 134 as shown and extend along longitudinal axis L. Chambers 116 provide a space or volume into which unbound (i.e. binder-free) activated carbon particles 122 may be received or deposited as indicated by arrows P in FIG. 4. By way of example, activated carbon particles 122 can be packed or pressed into chambers 116. In one exemplary embodiment of the invention, activated carbon particles having a nominal size in the range of about 25 microns to about 200 microns may be used. Other size ranges may be used as well.

As stated, activated carbon particles 122 that are placed in chambers 116 defined by filter block 110 do not contain binder that would otherwise block or bind some of the surface area of the particles and thereby reduce ability of the particles 122 to provide filtration through adsorption. For example, depending on the amount of binder, activated carbon particle size, binder size and compression of carbon particles, binder can displace carbon particles at roughly a 1:1 ratio and partially blind off the existing surface area of the carbon particles by roughly the percentage of binder being used. A filter block constructed with e.g., 45% binder will have only 75% (100% −(55% percentage of carbon particles in the block)×(45% amount of surface area being blinded off by the binder particles)) of the available surface area as that of a block of the same volumetric, porous nature with no binder. Thus, having a filter block 110 that provides significant amounts of activated carbon particles 120 that do not contain binder can greatly improve the overall surface area available for adsorption.

By comparison, the body 134 of filter block 110 is constructed with binder 120 to hold its activated carbon particles 118 into the desired shape. However, by carefully controlling the amount of binder 120 used, only a portion of the activated carbon particles 118 comprising filter block 110 will be bound or otherwise unavailable for adsorption. As such, as compared to a conventional filter block of the same size that uses e.g., non-activated carbon materials to construct the body of the filter block, the overall surface area of activated carbon available for adsorption using filter block 110 is significantly increased. For example, in one exemplary embodiment, body 134 of filter block 110 includes binder in a range of about 30 percent or less of the total weight of body 134 (before depositing unbound activated carbon present in chambers 116). In still another exemplary embodiment, body 134 of filter block 110 includes binder in a range of about 25 percent or less of the total weight of body 134 (before depositing unbound activated carbon present in chambers 116).

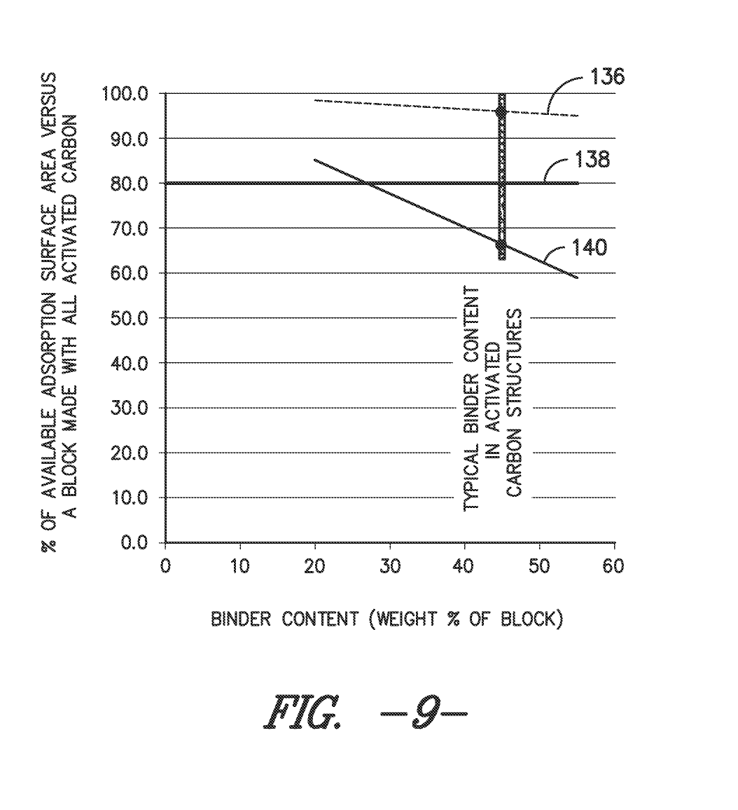

FIG. 9 provides a plot of certain data to further illustrate these concepts. Line 140 represents a 10 cubic inch, standard carbon block filter constructed with activated carbon particles held together by binder. As the amount of binder content increases (shown as a weight percent of the total weight of the carbon block), the percent of surface area available for adsorption decreases (the vertical line at 45 percent represents the typical binder content found in conventional filter blocks constructed of activated carbon.

Line 138 represents a conventional, 10 cubic inch, filter block constructed from a porous ceramic structure with honeycomb-shaped chambers that contain unbound activated carbon particles (i.e. binder free). Because no binder is present, the surface area available for adsorption remains constant and can provide significantly more surface area relative to filter block represented by line 140 as the amount of binder for line 140 increases.

Line 136 represents a 10 cubic inch filter block constructed e.g., according to an exemplary embodiment of the present invention where the body of the filter block is constructed from activated carbon bound together in a predetermined shape and forming honeycomb-shaped chambers filled with binder-free activated carbon. As shown, the filter block of line 136 has almost 46 percent more surface area available for adsorption that the filter block of line 140 and about 19 percent more surface area than the filter block of line 138.

Returning to FIGS. 2, 3, and 4, filter block 110 extends along longitudinal axis L between a first end 124 and a second end 126. First end 124 defines a plurality of openings 128 to chambers 116 through which non-bound, activated carbon particles may be deposited into chambers 116. A first cap 130 is attached to first end 124 and a second cap 132 is attached to second end 126. Caps 130 and 132 help ensure that the flow of unfiltered water is through external surface 112 of filter block 110.

As shown in FIG. 4, for this exemplary embodiment, filter block 110 is constructed with a plurality of uniformly spaced chambers 116 positioned around internal fluid passageway 114 and separated therefrom by the body 134 of filter block 110. In addition, along a cross-section orthogonal to the longitudinal axis L, chambers 116 appear to be square in shape. However, a variety of other shapes and configurations for filter block 110 may be used.

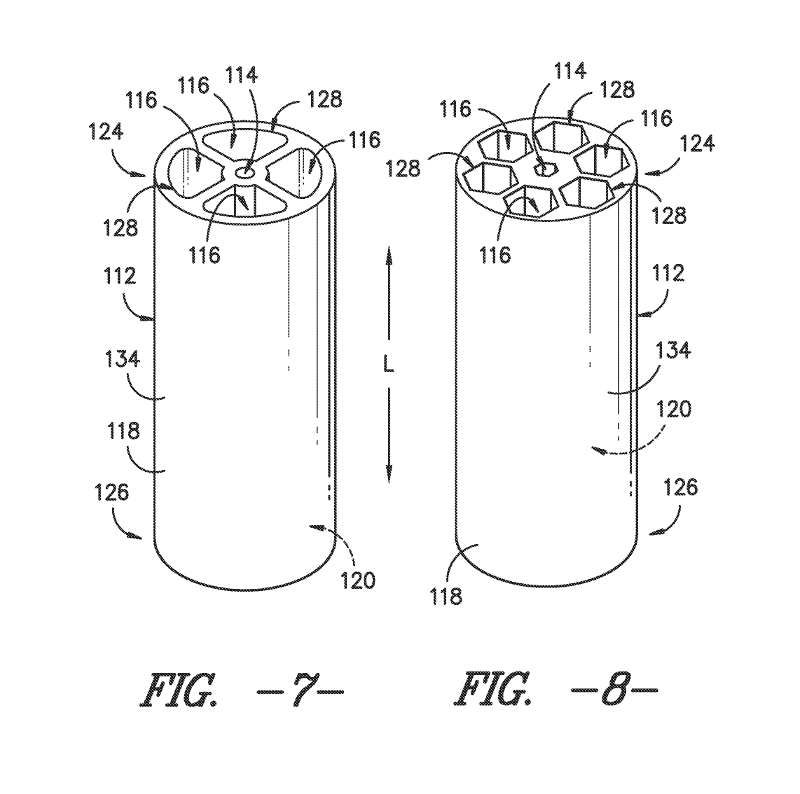

For example, FIG. 5 illustrates another exemplary embodiment of filter block 110 having single chamber 116 formed as an annulus by body 134. As with the previous embodiments, body 134 is formed from activated carbon particles held together by binder 120 in the shape desired. Unbound, or binder-free, activated carbon particles can be placed into chamber 116.

FIG. 6 illustrates another exemplary embodiment of filter block 110 having a plurality of chambers 116 as well as a plurality of internal fluid passageways 114. FIG. 7 illustrates still another exemplary embodiment of filter block 110 having a plurality of chambers 116 of a different shape from previous embodiments and including a single, internal fluid passageway 114. Finally, FIG. 8 illustrates still another exemplary embodiment of filter block 110 having a plurality of chambers 116 and a single internal fluid passageway 114. For this exemplary embodiment, chambers 116 have a hexagonal shape in a cross-section that is orthogonal to the longitudinal axis L. The density and number of chambers 116 can be increased to provide still another embodiment with a honeycomb shape in cross-section. Other configurations and shapes other than what is shown in the figures may be used as well.

Returning to FIG. 5, in still another exemplary embodiment of the present invention, body 134 could be formed from e.g., a media such as paper or a fiber based media. Such media could be impregnated with adsorption media. Fluid passageway 114 can still be formed from adsorption media held together by binder while chamber 116 is filled with unbound adsorption media. As such, this construction can be used to further reduce the amount of binder present in filter block 110.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A fluid filter, comprising:
a filter block defining a longitudinal axis, the filter block having an external surface for the inflow of unfiltered fluid, the filter block defining at least one internal fluid passageway extending along the longitudinal axis and configured for the receipt of filtered fluid from the filter block, at least one chamber extending along the longitudinal axis and separated from the at least one internal passageway by the filter block, the filter block further comprising
particles of an adsorption media
a binder that holds the particles together into a predetermined shape of the filter block; and
unbound particles of the adsorption media received into the at least one chamber and extending along the longitudinal axis.

2. A fluid filter as in claim 1, wherein the at least one chamber comprises a plurality of chambers extending along the longitudinal axis.

3. A fluid filter as in claim 2, wherein the plurality of chambers are separated from each other along the longitudinal direction by the filter block.

4. A fluid filter as in claim 1, wherein the filter block extends along the longitudinal axis between a first end and a second end, and wherein the first end defines at least one opening to the at least one chamber.

5. A fluid filter as in claim 4, further comprising:
a first cap attached to the first end to block the flow of fluid through the first end of the filter block; and
a second cap attached to the second end to block the flow of fluid through the second end of the filter block.

6. A fluid filter as in claim 1, wherein the at least one chamber defines a hexagonal shape in a cross-section that is orthogonal to the longitudinal axis.

7. A fluid filter as in claim 1, wherein the at least one chamber comprises a plurality of chambers extending along the longitudinal axis, the plurality of chambers being uniformly spaced and separated from each other by the filter block.

8. A fluid filter as in claim 1, wherein the filter block comprises binder in the range of about 30 percent or less by weight of the filter block.

9. A fluid filter as in claim 1, wherein the filter comprises binder in the range of about 25 percent or less by weight of the filter block.

10. A fluid filter as in claim 1, further comprising a housing into which the filter block is removably received.

11. A fluid filter as in claim 10, further comprising a filter manifold into which the housing is removably received.

12. A fluid filter as in claim 1, wherein the adsorption media comprises unbound activated carbon comprises particles in the range of about 25 to about 200 microns in size.

13. A fluid filter as in claim 1, wherein the binder comprises a polymeric material.

14. A fluid filtration device, comprising:
a filter block comprising
a body constructed from particles of an adsorption media held together by a binder,
an external surface of the body for the ingress of fluid to be filtered,
an internal fluid passageway within the body separated from the external surface by the body,
at least one chamber extending within the body separated from the at least one internal passageway by the filter block; and
binder-free particles of the adsorption media deposited within the at least one chamber.

15. A fluid filtration device as in claim 14, wherein the at least one chamber comprises a plurality of chambers extending along the body.

16. A fluid filtration device as in claim 14, wherein the body of the filter block defines a first end and a second end, and wherein the first end defines at least one opening to the at least one chamber.

17. A fluid filtration device as in claim 16, further comprising:
a first cap attached to the first end to block the flow of fluid through the first end of the filter block; and
a second cap attached to the second end to block the flow of fluid through the second end of the filter block.

18. A fluid filtration device as in claim 14, wherein the filter block comprises binder in the range of about 30 percent or less by weight of the filter block.

19. A fluid filtration device as in claim 14, wherein the filter comprises binder in the range of about 25 percent or less by weight of the filter block.
